(19) United States
(12) Patent Application Publication
(10) Pub. No.: US 2015/0084220 A1
(43) Pub. Date: Mar. 26, 2015

(54) MULTIFUNCTIONAL DENTAL WORKSTATION

(71) Applicant: Patrick Cox, Sligo (IE)

(72) Inventor: Patrick Cox, Sligo (IE)

(21) Appl. No.: 14/396,394

(22) PCT Filed: Apr. 23, 2013
(86) PCT No.: PCT/IB2013/000749

§ 371 Date: Oct. 23, 2014

(30) Foreign Application Priority Data
Apr. 23, 2012 (GB) GB1207117.1

(51) Int. Cl. A61C 13/00; H05B 6/14

(52) U.S. Cl. CPC A61C 13/0028; H05B 6/14
USPC 264/16; 219/601

(57) ABSTRACT

A multifunctional dental workstation for manipulating and shaping dental wax comprises a plurality of electric hotplates; an electrically controlled knife power socket, control panels; and an induction coil heater. The workstation comprises at least two electric hotplates.

### INTRODUCTION

The invention relates to a multifunctional workstation or workbench for housing equipment required to manipulate and shape dental wax.

There are a variety of different devices on the market for use in dental practices or dental laboratories to enable a dentist and/or laboratory technician make dentures. Heating means such as Bunsen burners, hot air, hot water and other heating devices are commonly used for softening dental wax used in the manufacture of dentures.

There is a need for an improved apparatus which has the necessary equipment to produce dental prosthesis.

### STATEMENTS OF INVENTION

According to the invention there is provided a multifunctional dental workstation for manipulating and shaping dental wax comprising;
a plurality of electric hotplates;
an electrically controlled knife power socket;
control panels; and
an induction coil heater.

Preferably the multifunctional dental workbench comprises at least two electric hotplates. In one embodiment of the invention the multifunctional dental workbench comprises at least three electric hotplates.

In one embodiment of the invention one of the hotplates is used to soften sheets of dental wax. Preferably the hotplate is operates at a temperature of between 50 and 52° C.

In one embodiment of the invention one of the hotplates is used to soften wax bite block rims and wax for squash bites. Preferably the hotplate operates at a temperature of between 38 and 45° C.

In another embodiment of the invention one of the hotplates is used to reduce a wax block rim. Preferably the hotplate is mounted on a side of the workstation at an angle of approximately 5 degrees off the vertical plane. Most preferably the hotplate comprises a channel along the bottom edge of the hotplate, to divert any molten wax into a container.

In one embodiment of the invention the workstation comprises a heat source hot-dock or hotplate to heat a plurality of metal inserts. Preferably the hot-dock comprises means for docking and heating the metal inserts. The heated metal inserts are inserted into bite blocks to compensate for missing teeth to obtain a positive and repeatable bite registration.

Preferably the metal inserts are of a material capable of being heated to approximately 120-130° C. Most preferably the metal inserts are of stainless steel or zinc die casting.

In one embodiment of the invention the workstation comprises tweezers to handle the heated metal inserts.

In one embodiment of the invention the induction coil heater is used for rapid heating of wax sculpting knives.

In one embodiment of the invention the workstation comprises dual electrically controlled power sockets for receiving dental knives. Preferably a dental knife comprising a resistance element is heated with current from one of the electrically controlled knife power sockets.

In one embodiment of the invention the workstation uses less than 1 kilowatt of electricity in 20 hours.

Preferably the temperature of the hotplates and heat source dock are individually controlled.

In another embodiment of the invention the workstation comprises means on a side of the workstation to house/hold a bio-fuel alcohol bottle torch.

According to the invention there is also provided a method of manufacturing dentures by manipulating and shaping dental wax using the multifunctional dental workstation of the invention.

### BRIEF DESCRIPTION OF THE INVENTION

The invention will be more clearly understood from the following description thereof with reference to the accompanying drawings in which:

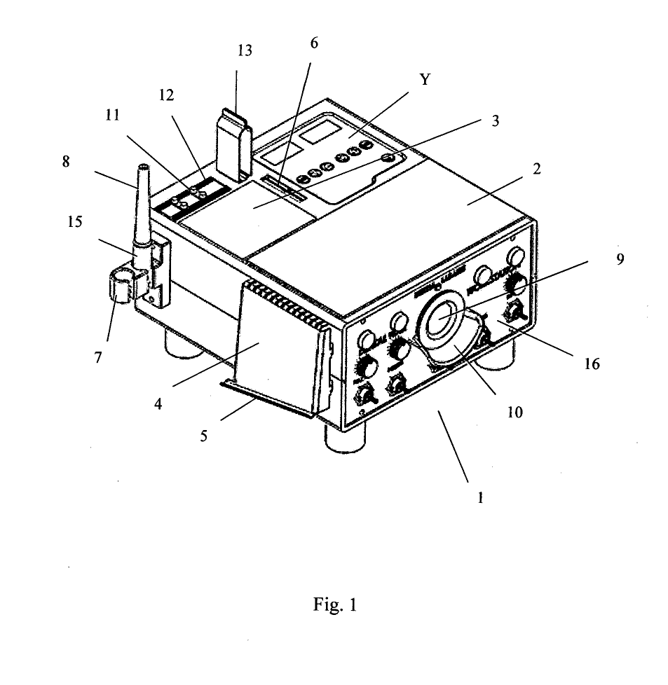

FIG. 1 is a perspective view of the multifunctional workstation of the invention;

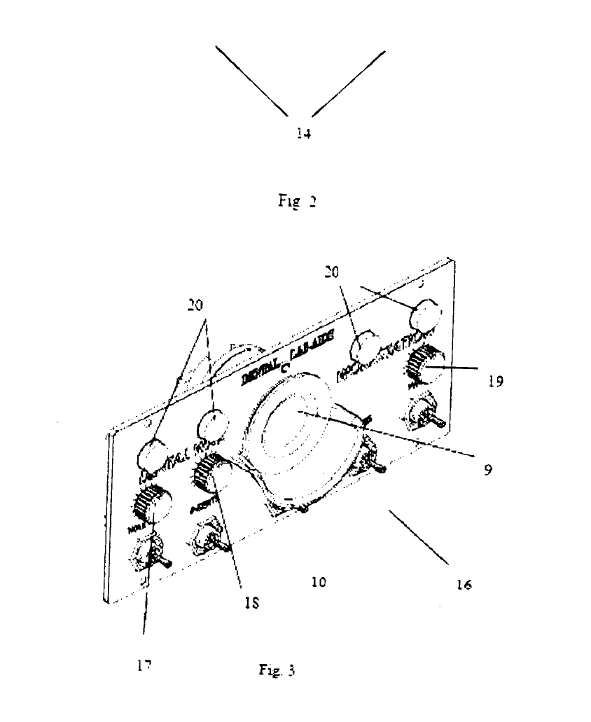

FIG. 2 is a perspective view of height gauges used in combination with the multifunctional workstation of the invention;

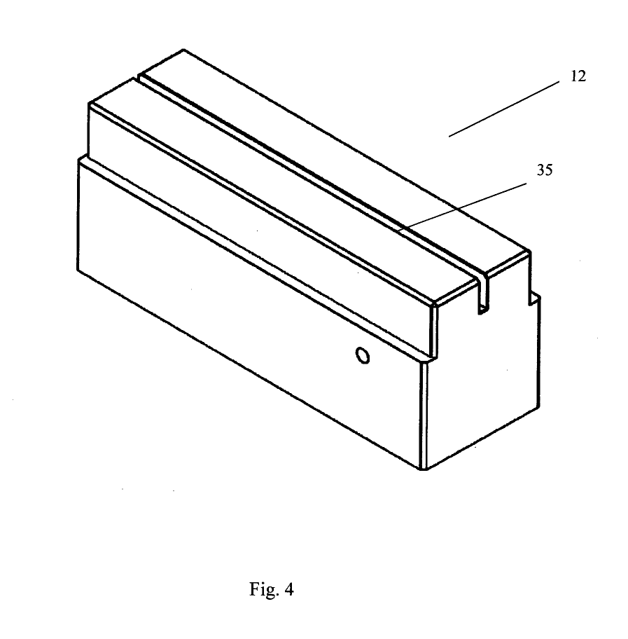

FIG. 3 is a perspective view of the front panel assembly of the multifunctional workstation of the invention;

FIG. 4 is a perspective enlarged view of the hot-dock on the multifunctional workstation of the invention.

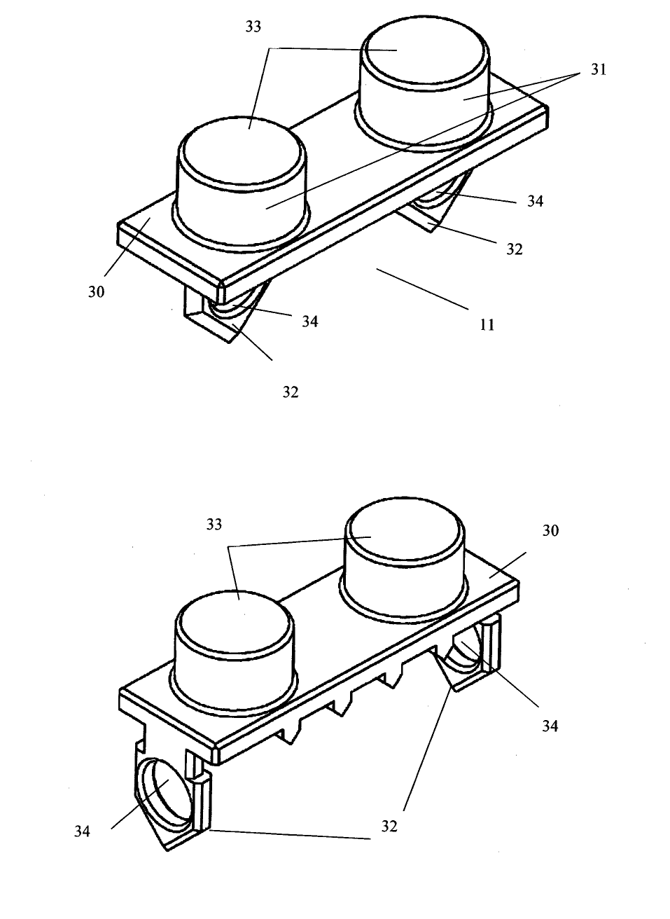

FIG. 5 is a perspective view of a metal insert of the invention;

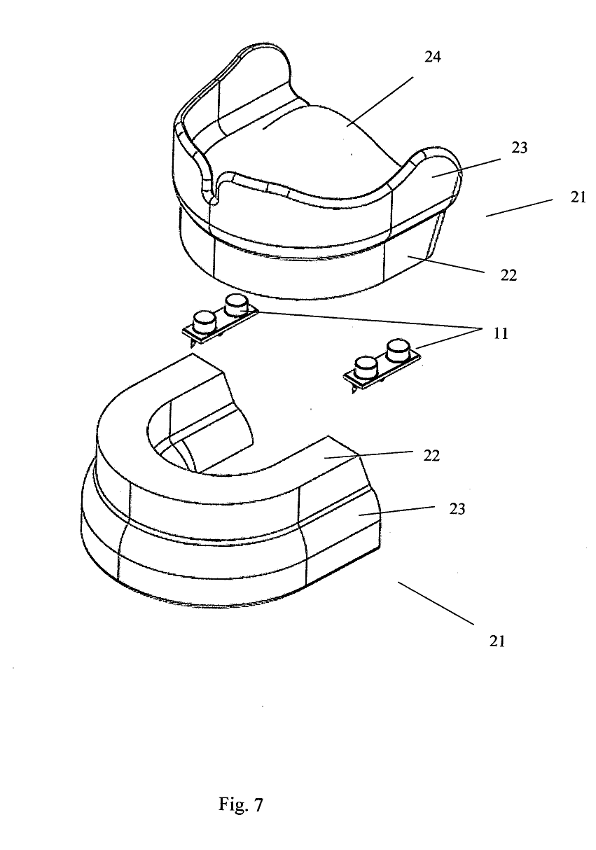

FIG. 6 is a perspective view of a metal insert according to another embodiment of the invention; and

FIG. 7 is a perspective view of an upper and lower jaw bite block model.

### DETAILED DESCRIPTION

When a dental patient requires new dentures or false teeth, typical steps in the manufacture of the denture include the following;
a dentist taking an impression of the gums and teeth (if any) in the upper and lower jaw of the patient;
the dentist or a dental laboratory technician constructing a plaster model of the upper and lower jaw of the patient from the impression;
the dentist determining the “bite” of the patient by melting and softening wax in a dental bite block or using a wax squash bite to enable accurate measurement of the “bite” of a patient; and
constructing the dentures.

Several visits to the dentist are usually required. In many cases additional unnecessary visits are required to achieve the correct fitting before the dentures are finally ready to be manufactured. When the dentist has made alterations the altered models typically need to be sent to a dental laboratory for alteration and then back to the dentist for re-fitting.

Correct bite registration is an essential condition for the functional success of a dental prosthesis. This is the means to the 3-dimensional determination of the position relation of the lower to the upper jaw with the aid of centric bite registration or bite plates.

The determination of the bite of a patient is one of the most important steps in the preparation of a dental prosthesis. If the bite is under-estimated, the patient will experience over-closing of the jaw when the dentures have been fitted. This can result in a lot of pain and stress and future problems. If the bite is over-estimated, the dentures prevent the proper closing of the jaw. Again this can lead to a lot of pain, discomfort and embarrassment.

The current manufacturing process used in the production of dental prosthesis requires updating and modernisation. Impressive advances in crown and bridgework, 3D printing and the use of computerised numeric control (CNC) milling machines have been made in recent years, however the basic process for producing dental prosthesis has not changed in decades.

The present invention provides a universal multifunctional bench-top workstation for housing most if not all the equipment required to manipulate and shape dental wax in the process of manufacturing dentures or dental prosthesis. The compact multifunctional workstation improves the working environment for both dentists and dental technicians.

The multifunctional bench-top workstation invention is intended for use by dentists' themselves in their practice rooms or by dental technicians in a dental laboratory.

Used in a dental practice the multifunctional workstation of the invention will lessen the number of visits a patient needs to make to the dentist when getting new dentures fitted. A dentist will be easily and quickly able to alter bite registrations and re-fit them in the patient's mouth without having the delay of sending altered bite registration measurements to a dental laboratory for re-working.

Using the multifunctional workstation of the present invention many of the required operations involved in manufacturing a new set of dentures may be performed with fewer visits to the dentist.

Typically Bunsen burners and other types of heating methods have been used to heat dental tools such as wax sculpting knives or softening sheets of dental wax used in the process of establishing bite registration, making bite blocks, special trays and waxed up dentures. Waxed up dentures are used for try-in prior to final dentures.

In complete contrast the multifunctional workstation of the present invention is powered by electricity thereby eliminating the need for fossil fuels such as gas in the denture manufacturing process. The multifunctional workstation of the invention will enable dentists and dental laboratories to avoid paying fossil fuel taxes and reduce the carbon footprint of the industry. If renewable electricity is used to power the multi-functional workstation of the present invention it will result in a carbon neutral process.

Once the multifunctional workstation is switched on to a mains electricity power supply, a dentist or dental technician may easily control the different temperature levels required on the different sections of the workstation using a combination of manual and digital controls. The heating effect is instant and the multifunctional workstation of the invention allows a dentist to quickly manipulate and alter for example a sizing on a dental bite block wax rim. The temperatures on all the hotplates of the multifunctional workstation are factory set at their optimum temperatures. The user may then raise or lower the temperature as required using the controls on the front panel. The controls are potentiometers and turning counter clockwise from the factory set mark will reduce the heat and turning clockwise increases the temperature. Digital controls may be linked to the hotplates if required.

The multifunctional dental workstation of the invention is very economical on power typically using less than 1 kilowatt of electricity in 20 hours. The individual hotplates are not all used all at the same time and the induction coil heater unlike the hotplates only draws down current when a knife is inserted.

In terms of health and safety the electric multifunctional workstation of the present invention provides a much safer working environment for the user in comparison for example to using the open flame of a Bunsen burner or the like to heat materials required.

FIG. 1 shows the multifunctional workstation 1 of the invention. A large electric hotplate 2 is used for softening single sheets of dental wax, making them fit for purpose. A smaller electric hotplate 3 is used to soften bite block wax rims or wax squash bites used for patient bite registration. Both hotplates 2 and 3 are positioned in a horizontal position on the upper surface of the workstation 1. A wax squash bite is a piece of softened dental wax which is shaped by the hand of the dentist to fit the patient. It is placed between the patients teeth and when the patient bites down it forms a registration of the patients bite.

A third electric hotplate 4 is mounted on the side of the workstation 1 and lies at an angle of approximately 5 degrees off the vertical plane and is used for reducing the height of a dental wax rim. Hotplate 4 is called a wax rim reducer. A channel 5 at the bottom of the hotplate 4 is used to divert any molten wax on the hotplate 4 into a container. The channel 5 is approximately 10 degrees off the horizontal plane. The channel 5 ensures that the dentist or technician's workbench or desktop is kept free of dental wax. The wax rim reducer hotplate 4 is used in conjunction with detachable height gauges 14. The detachable gauges 14 as shown in FIG. 2 are made to an industry norm for the initial set up of bite blocks.

There are typically four gauges of varying heights, 16 mm, 18 mm, 20 mm and 22 mm. The technician or dentist selects the gauge they need and scribes a mark by hand on a bite block rim. The dentist aligns the dental wax rim to the required height gauge and if the rim is too high the dentist presses wax block rim against the reducer hotplate 4 to reduce the rim to the scribed mark.

The detachable gauges 14 are mounted in receiving slots 6 near the control panel [indicated at Y] on the top surface of the multifunctional workstation.

The hotplates on the multifunctional workstation 1 of the invention comprise silicone heater mats with precision temperature control units. The thermistor accuracy is in the region of 1-3%. Heating films like infrared “heating films” may also be used in place of silicone heater mats.

Both electric hotplates 2 and 3 mounted on the upper surface of the workstation 1 for wax softening are coated with polytetrafluoroethylene (PTFE) to minimise the adherence of dental wax. A silicone oil release agent may be applied to the PTFE surface to ensure that the wax sheet does not adhere or leave traces of wax on the surface of the hotplate. The large hotplate 2 should be cleaned and new release agent applied each time a new sheet of wax is used. This prevents a build up of old release agent and keeps the unit clean.

The rim reducer hotplate 4 is mirror finish stainless steel and does not require a PTFE coating. The temperature on the rim reducer hotplate 4 is set to a temperature that melts wax and can be wiped clean while hot. A hot-dock or hotplate 12 for docking an heating metal inserts 11 may be made from copper or brass and may be polished or plated with chromium or other plating process to prevent corrosion and for aesthetic reasons. The rim reducer hotplate 4 and the hot-dock or hotplate 12 would not need the application of a release agent. The hotplates on the multifunctional workstation 1 of the invention may also be used by dentists' to heat mirrors for intraoral photography. It prolongs the time the mirror can be in the patient's mouth before fogging up.

The larger hot plate 2 is heated by a 12 Vdc 40 watt silicone heater mat and the second smaller hotplate 3 is heated by a 12 Vdc 5 watt silicone heater mat. The temperature generated in the smaller hotplate 3 heated by a 12 Vdc 5 watt silicone heater mat is sufficient and ideal for softening bite rims in the dental laboratory and wax for squash bites in the dental surgery. Typically the temperature required with the larger hotplate 2 is in the range of between 50 and 52° C. The temperature required with the smaller hotplate 3 is typically in the range of between 40 and 45° C.

The temperature on hotplate 4 is typically factory set to 120° C. to ensure a speedy reduction of a wax bite rim. The hot-dock 12 for the metal inserts 11 may be factory set to 120° C. In both cases a 140° C. thermostat is installed to avoid meltdown in the case of thermistor failure.

The larger hotplate 3 is factory set at the optimum temperature however the user may increase or decrease the temperature to suit the application using the potentiometer knob 17 located on the front panel 16 as shown in FIG. 3. The temperature of the various hotplates 2, 3, 4 may be regulated using the controls 17, 18, 19 on the front panel 16. Indicator lights 20 allow the user to determine when the set temperatures have been reached.

The multifunctional workstation 1 of the invention has an electric heating dock or hot-dock 12 for heating metal inserts 11. The hot-dock 12 is heated with a 20 watt electric cartridge heater. The cartridge is inserted into a hole in the core of the block (not shown).

FIG. 4 shows a close up of the hot-dock 12 on the upper surface of multifunctional workstation 1. An anchoring slot 35 runs along the top of the hot-dock 12. Three metal inserts 11 may be docked or anchored and heated on the hot-dock 12 at any one time. This would be sufficient for preparing a denture model for a single patient. The projections or pointed notches 32 on the metal inserts 11 are anchored in the anchoring slot 35.

The metal inserts 11 are small. They may be approximately 6 mm wide×18 mm long high and a tweezers 13 is located beside the heating dock 12 for easy handling of the metal inserts 11. The metal inserts 11 are used to ensure a good bite registration for patients with few or no teeth. The metal inserts 11 may be of any metal that can be heated to 150° C. and not cause a toxic reaction in patients. Preferably the inserts are of stainless steel or zinc die casting. Alternatively the inserts may be of any suitable material capable of being heated to a high temperature.

FIGS. 5 and 6 show two embodiments of metal insert 11 which may be used. The metal inserts 11 comprise a rectangular plate 30 having two circular upstands or notches 31 protruding on the upper side of the rectangular plate 30. The notches may be 5 mm diameter×3 mm high. On the lower side of the rectangular plate 30 are two protruding pointed notches 32. The projections or pointed notches 32 allow easy insertion of the metal inserts when heated into a bite block. When the heated metal insert 11 is inserted into a bite block the upper surface 33 of the two protruding circular upstands 31 are flush with the outer surface of the bite block. The circular upstands 31 act as teeth.

The projections or pointed notches 32 are designed to self-anchor into the wax rim. Any form of self-anchoring of the insert in a bite block may be used. Because of the temperature of the insert molten wax will flow into the holes 34 in the projections or pointed notches 32. As a result the inserts do not move easily when the wax cools and sets.

The multifunctional workstation 1 of the invention has a digitally controlled electrically powered knife socket 7. The knife sockets' 7 may hold up to two knives 8. The female socket 7 supplies 12 VDC power from the workstation to the knife. A male bayonet 15 is attached to the cable of the electric knife. Typically the socket 7 has a 3.5 mm diameter to accommodate the bayonet 15 of a conventional dental knife. The bayonet is connected into socket 7. A knife 8 is then inserted into the bayonet 15. The knife 8 has a resistance element which heats up when power is supplied. The electric knife takes a few minutes to come up to temperature and it is constantly on and using electricity. The temperature of the knife is controlled and may be seen on a digital readout on the control panel [indicated at Y] located on the upper surface of the workstation 1. The temperature of a knife held within power socket 7 may be adjusted as required.

Typically a dental technician or dentist will have their own favourite electric knife which may be inserted into power socket 7 on the workstation 1. Electric knives are used to shape dental wax. Electric knives are typically used with fine tips for the waxing up of chrome/cobalt dentures and for crown and bridgework.

The multifunctional workstation 1 of the invention has an induction coil heater 9 for rapidly heating wax sculpting knives [not shown]. Wax sculpting knives are commercially available and are typically larger than the electric knives used for finer work. The wax sculpting knives are placed in the induction coil heater 9 for several seconds to allow the knives to heat up to the required temperature. The induction coil heater only draws down current when the knife is inserted. Using the induction coil heater 9 on the multifunctional workstation 1 is a much faster means of heating wax sculpting knives in comparison to traditional methods of using the open flame of a Bunsen burner.

The induction coil heater 9 has an outer lip 10 for supporting the handle of the knives when the knives are being heated in the induction coil heater 9. The outer lip 10 also acts as a wax drip guard to prevent molten wax on the knife from dripping onto the switches located below the induction coil heater 9 on the front panel 16 of the workstation 1. Sculpting knives are used to sculpt wax on bite blocks, special trays and waxing up of dentures.

On the rear panel of the multifunctional workstation 1 there are typically six fuse holders and two power sockets. These are standard 3.5 mm electrical connectors. They are used to transfer DC current from a power source to the compatible multifunctional workstation. The voltage is typically 12 VDC. A 12 VDC power adaptor within the workstation converts any 220 VAC supply to 12VDC.

In one embodiment of the invention there may be at least five electrical units in the workstation including the rim reducer hotplate, metal inserts hot-dock, induction coil heater, electric knife and the dual hotplates. A spare or an added unit like a hot melt gun may also be included.

The workstation has a series of slots to vent hot air generated by the hotplates. The hot air venting slots may be located on the top of the workstation or along the side of the workstation. A fan located inside the workstation is used to force the hot air generated out of the unit.

Current methods of preparing a model of a patient's teeth involve wax bite blocks being inserted into the patient's mouth and the rims marked in several places. The marked bite blocks are then sent to a dental laboratory where the bite block is used as an aid to the technician to establish the patients bite registration. This method is very prone to error and rework is frequently required involving several visits by the patient to their dentist.

To obtain the bite registration of a patient a “bite block” 21, a wax rim resembling a denture shape, as shown in FIG. 7, is placed into the patient's mouth and skillfully trimmed and manipulated to obtain the correct contour and length. The bite blocks must be of a material designed to be malleable when heated to a certain temperature and rigid at room temperature so that the patients bite is recorded. Special measurements such as: centre, lip length and jaw relationship are taken. This can be a lengthy process.

Using the multifunctional workstation 1 of the present invention a dentist is able to instantly make any required alterations on bite blocks. It is important that the patient be relaxed and responsive during the procedure in order to achieve the best fit.

The following is an outline of the steps involved in preparing a denture. If the patient has a few teeth on the top and bottom jaw the dentist will commission a dental lab to make bite blocks for the top and bottom gums. FIG. 7 shows a bite block 21 for an upper jaw A and a lower bite block for a lower jaw B.

The dentist first ensures that the bite rims on the bite block are the correct height to suit the patient. The bite block 21 consists of a wax rim 22 which are fixed on the gum ridge 23. The gum ridge 23 is on a wax plate or form 24 which is shaped to a plaster impression of the patient's upper palate or lower gum line when soft and fit for purpose.

If the patient has a few teeth heated metal inserts may be inserted in place of the missing teeth in the bite block rims. The inserts are heated for ease of insertion in the softened bite block rims 22. The metal inserts act as teeth and make an impression in the opposite bite rim.

The dentist then softens a second bite block on the hotplate 3. If the dentist has put inserts in the upper bite block rim 22 then he must soften the lower bite rim to facilitate ease of impression. In that way it is possible and preferable for the metal inserts 11 to be cool and properly set in the wax rim. If a patient has few or no teeth a minimum of two metal inserts 11 are placed in the rim of one of the bite blocks 21.

The bite blocks 21 are inserted into the patient's mouth. The mouth is closed and the inserts 11 fully indent into the softer wax rim. This allows the bite registration and shut height to be determined. When the patient bites down the inserts 11 make a very definite indentation in the opposite rim 22. This method ensures a very positive bite registration. It also improves the quality of the registration and reduces rework.

Using the workstation 1 of the present invention to obtain an accurate bite registration a whole stage in the current process for manufacturing a dental prosthesis is eliminated.

Currently a dentist will soften both bite rims and when the patient closes his or her mouth the top adheres to the bottom and he or she will then scribe lines on the wax rim. The dental technician must separate the two bite blocks, then pour in plaster to create a plaster model of the patients palate and gum line. The technician then mounts these plaster models with the bite blocks in an articulator and uses the lines to align upper and lower bite blocks. An articulator is a device which takes the place of the patient's mouth and is linked together by a hinge mechanism which very roughly mimics the patient's mandibular joint or opening and closing movement.

At a dental laboratory when a wax bite block is being made the technician finishes the rims at an acknowledged average height. For a lower block they will finish to a height of 16-18 mm and for an upper he/she will finish at 20-22 mm. They will always try to err on the high side.

Using the multifunctional workstation 1 of the present invention the dental technician can use the wax rim reducer hotplate 4 with the four gauges having a size range of between 16-22 mm to scribe a mark on the bite block rim. The dentist or dental technician can press the wax rim against the wax rim reducer hotplate 4 until it reduces to the scribed mark. The bite blocks are then ready to be re-fitted in the patient's mouth.

Using the multifunctional workstation 1 of the present invention a dentist is also able to make alterations to the wax rim if required without having to send the wax rim to a dental laboratory using the wax rim reducer hotplate 4. In this way the wax rims may be manipulated in situ either to shorten the rims or soften wax on one of the hotplates to increase the height, while the patient is still present. The bite blocks may be re-fitted in the patient's mouth to ensure the correct fitting has been achieved.

The multifunctional dental workstation 1 of the invention may comprise means on the side of the workstation for containing an alcohol bottle torch [not shown]. The alcohol bottle torch may be held in a type of docking station or nest. The alcohol bottle torch is for fire polishing of dental wax and is the only time a naked flame is required in the process of manipulating and shaping dental wax using the multifunctional dental workstation of the invention. When a denture is ready for fitting a waxed up denture is used. The dentist and patient must be satisfied with the fit and appearance before a final acrylic or chrome denture is made. A naked flame is the only way to provide a good finish to the denture. Having an alcohol bottle torch which is small and easy to control within easy reach in a holder on the side of the workstation makes it very user friendly. The alcohol bottle torch may be attached to the multifunctional dental workstation of the invention using a holster or releasable clamp means.

The alcohol bottle torch uses bio-fuel and has zero carbon emissions. The torch is commercially available.

Currently a lot of time is spent trying to ensure a definite and repeatable bite registration for a patient prior to their dentures being manufactured. Current procedures involve a lot of re-working of bite blocks and/or plaster models in order to get the correct sizing.

The multifunctional dental workstation of the present invention housing most of the equipment necessary for wax manipulation in Labs and Dental surgeries may be used by a dentist or dental technician to easily and efficiently carry out the various procedures required in the preparation of dental models and dentures.

The following are examples of work that may be carried out using the multifunctional dental workstation of the present invention.

### EXAMPLE 1

### Preparing and Manipulating Bite Blocks

The dentist sends an impression of the patients bite to the lab. A dental technician makes a plaster model from the impression. Dental wax which has been softened and made fit for purpose on the large hotplate 2 is pressed onto the plaster model. The wax bite rim which has been softened and made pliable on the smaller hotplate 3 is mounted on the gum rim of the wax already on the plaster model. The rim is held in place by molten wax which is applied to it by a wax sculpting knife which is heated in the induction coil heater 9. The molten wax may be picked up from a sheet or waste wax piece for example. The sculpting knife is used to smooth and distribute the hot wax to where it is required. The alcohol bottle torch is used to fire polish the finished bite block and make it look good. A height gauge 14 is used to mark the required height and the rim reducer is used to reduce the rim to the marked height. The model is then ready to be sent back to the dentist.

### EXAMPLE 2

### Chrome Cobalt Denture

A technician takes a plaster model and designs and sketches the chrome cobalt frame on to it. They then attach pre-moulded wax tracks and seal them to each other and to the plaster model using the very fine tip on the electric knife 8 supplied with the universal dental wax workstation 1 of the invention. The chrome cobalt frame is then cast using the lost wax principle. i.e. the wax is melted and replaced with the molten chrome cobalt metal. The frame is then polished and acrylic and teeth are added to create a denture.

### EXAMPLE 3

### Acrylic Denture

A technician takes plaster models and mounts them in an articulator. They align top and bottom using a squash bite or bite blocks supplied by the dentist. The models are cemented to the upper and lower frame of the articulator. The technician wax's up and installs teeth in the wax and ensures the bite is aligned properly. Using a sculpting knife which has been heated in the induction coil heater 9 they shape and manipulate the waxed up denture. The wax up is then sent to the dentist for try-in. The dentist will fit the try-in in the patient and make alterations as required using a wax sculpting knife heated in the induction coil heater 9. When satisfied with the fit the try-in is sent back to the lab for completion. The technician will replace the wax with acrylic using one or two different methods. They need to ensure that the bite is still correct. The acrylic denture is polished and returned to the dentist for fitting. The dentist will fit the denture to the patient and make alterations to ensure a comfortable fit.

The multifunctional workstation 1 of the invention is effectively a third hand for the dentist or dental technician as it can be softening wax while other work is being done. The multifunctional workstation of the invention will assist the dentist or technician to easily reduce the height of a wax bite rim to suit the patient. The sizing on a bite block rim may be easily altered. The multifunctional workstation 1 of the invention provides instant heat for a wax sculpting knife by means of the incorporated induction heater coil system. The multifunctional workstation 1 enables dentists and technicians to do very fine wax work using an electric knife which has been heated using the incorporated digitally controlled power socket. The multifunctional workstation 1 will also allow the dentist or technician to plug in a favourite electric wax knife alongside a supplied knife. The multifunctional workstation of the invention allows a dentist to establish a positive bite registration for patients who have few or no teeth by using the metal inserts 11 which have been heated on the hot-dock or hotplate dock 12 on the workstation 1.

The invention is not limited to the embodiments herein before described which may be varied in detail.

1. A multifunctional dental workstation for manipulating and shaping dental wax comprising;
a plurality of electric hotplates;
an electrically controlled knife power socket;
control panels; and
an induction coil heater.

2. A multifunctional dental workbench as claimed in claim 1 comprising two electric hotplates.

3. A multifunctional dental workbench as claimed in claim 1 comprising three electric hotplates.

4. A multifunctional dental workstation as claimed in claim 1 wherein one of the hotplates is used to soften sheets of dental wax.

5. A multifunctional dental workstation as claimed in claim 4 wherein the hotplate operates at a temperature of between 50 and 52° C.

6. A multifunctional dental workstation as claimed in claim 1 wherein one of the hotplates is used to soften wax bite block rims and wax for squash bites.

7. A multifunctional dental workstation as claimed in claim 6 wherein the hotplate operates at a temperature of between 38 and 45° C.

8. A multifunctional dental workstation as claimed in claim 1 wherein one of the hotplates is used to reduce a wax block rim.

9. A multifunctional dental workstation as claimed in claim 8 wherein the hotplate is mounted on a side of the workstation at an angle of approximately 5 degrees off the vertical plane.

10. A multifunctional dental workstation as claimed in claim 8 wherein the hotplate comprises a channel along the bottom edge of the hotplate, to divert any molten wax into a container.

11. A multifunctional dental workstation as claimed in claim 1 wherein the workstation comprises a plurality of receiving slots along its top surface to store detachable height gauges and vent hot air generated by the hotplates.

12. A multifunctional dental workstation as claimed in claim 1 comprising a heat source hot-dock or hotplate to heat a plurality of metal inserts, the hot-dock comprising means for docking and heating the metal inserts, the metal inserts formed of a material, such as stainless steel or zinc die casting, capable of being heated to approximately 120-130° C., wherein the heated metal inserts are inserted into wax bite blocks to compensate for missing teeth to obtain a positive and repeatable bite registration.

13-16. (canceled)

17. A multifunctional dental workstation as claimed in claim 12 comprising tweezers to handle the heated metal inserts.

18. A multifunctional dental workstation as claimed in claim 1 wherein the induction coil heater is used for rapid heating of wax sculpting knives.

19. A multifunctional dental workstation as claimed in claim 1 comprising dual electrically controlled power sockets for receiving dental knives.

20. A multifunctional dental workstation as claimed in claim 19 wherein a dental knife comprising a resistance element is heated with current from one of the electrically controlled knife power sockets.

21. A multifunctional dental workstation as claimed in claim 1 wherein the workstation uses less than 1 kilowatt of electricity in 20 hours.

22. A multifunctional dental workstation as claimed in claim 1 wherein the temperature of the hotplates are individually controlled.

23. A multifunctional dental workstation as claimed in claim 1 comprising means on a side of the workstation to contain a bio-fuel alcohol bottle torch.

24. (canceled)

25. A method of manufacturing dentures by manipulating and shaping dental wax using the multifunctional dental workstation as claimed in claim 1.
